(19) United States
(12) Patent Application Publication
(10) Pub. No.: US 2013/0000626 A1
(43) Pub. Date: Jan. 3, 2013

(54) OVEN DOOR WITH A PLASTIC DOOR COLUMN AND A METHOD FOR ASSEMBLING SAID PLASTIC DOOR COLUMN

(75) Inventors: Andreas Trautner, Neuendettelsau (DE); Christoph Bluml, Schillingsfurst (DE); Erhardt Koitzsch, Rothenburg (DE)

(73) Assignee: ELECTROLUX HOME PRODUCTS CORPORATION N.V., Brussels (BE)

(21) Appl. No.: 13/518,370

(22) PCT Filed: Dec. 22, 2010
(86) PCT No.: PCT/EP10/70514

§ 371 Date: Sep. 4, 2012

(30) Foreign Application Priority Data
Dec. 30, 2009 (EP) 09 016 120.9

(51) Int. Cl. F24C 15/02; B23P 11/00

(52) U.S. Cl. 126/194; 29/428; 29/525.01

(57) ABSTRACT

The present invention relates to an oven door with at least one elongated plastic door column and at least one corresponding door hinge. The door hinge includes an elongated door part and an oven part. The plastic door column includes an elongated channel for receiving the door part. The channel extends from one end of the plastic door column parallel to the longitudinal axis of said plastic door column. The door part is detachably mountable within the channel. A leaf spring for clamping the door part is durably fixed within the channel. A section of the leaf spring is complementary with a corresponding section of the door part. Further, the present invention relates to a corresponding plastic door column and a method for assembling said plastic door column.

The present invention relates to an oven door with at least one plastic door column and at least one corresponding door hinge. Further, the present invention relates to a plastic door column and a method for assembling said plastic door column.

The oven door with the plastic door column is usually arranged at the oven via a door hinge, wherein one part of the hinge is fixed at the oven and another part of the hinge is fixed in the plastic door column. In particular, the oven door comprises two plastic door columns and two corresponding hinges.

For fixing the door hinge in the plastic door column on the oven door it is necessary to use a hook, a slider or a screw. In order to fix and to unfix plastic door column and hence the oven door a tool or some special mounting steps are required. Said special mounting steps are not easy and require background knowledge.

It is an object of the present invention to provide an oven door with at least one plastic door column, which can be removed and fixed at the oven without any tool and special knowledge.

The object of the present invention is achieved by the oven door according to claim 1.

According to the present invention the oven door includes at least one elongated, preferably plastic, door column and at least one corresponding door hinge, wherein:
the door hinge includes an elongated door part and an oven part,
the door column includes an elongated channel for receiving the door part,
the door part is detachably mountable or detachably mounted within the channel,
a leaf spring for clamping the door part is durably (or: permanently) fixed within the channel,
the leaf spring is directly fixed at the door column or door part, and
a section of the leaf spring is complementary with a corresponding section of the door part or door column.

The main idea of the present invention is the durably fixed leaf spring for clamping the door part or door column, wherein the leaf spring is directly fixed at the door column or door part and the section of the leaf spring is complementary with the corresponding section of the door part or door column. The user does not need any tool or any special tricks in order to remove and fastening the plastic door column and hence the oven door. Further, the user does not need any fixing elements for fastening the leaf spring. Since the leaf spring is arranged within the channel, the leaf spring is not visible.

According to a preferred embodiment of the present invention the leaf spring and the door part or door column form a snap-in mechanism. The snap-in mechanism allows an easy handling for the user.

In particular, the leaf spring includes at least one lug directed to the door part or door column in a mounted state. Accordingly, the door part or door column includes at least one recess for receiving the lug of the leaf spring.

Preferably, an outer side of the lug forms an acute angle with a principle plane of the leaf spring. In contrast, an inner side of the lug forms an obtuse angle with the principle plane of the leaf spring. The different angles of the leaf spring allow different pulling and pushing forces for removing and assembling, respectively, the oven door.

Further, the snap-in mechanism is formed by the lug of the leaf spring and the recess.

Preferably the channel extends from one end of the door column at least mainly and/or approximately parallel to a longitudinal axis of said door column. A slight inclination could also be advantageous.

The present invention relates further to the door column, which is provided for the oven door as described above.

The object of the present invention is also achieved by the plastic door column according to claim 9.

The present invention relates also to a method for assembling a, preferably plastic, door column for receiving a door part of a door hinge and a leaf spring for clamping the door part, wherein the door column is formed as a single-piece part in particular by plastic coating, the leaf spring is directly fixed at the door column, and at least one fixing element for fastening the leaf spring is formed as an integral part of the door column.

There are in particular different methods for fixing the leaf spring at the door column.

A first embodiment of the method is characterized by the steps:
forming the door column by plastic coating,
inserting the leaf spring into a channel for receiving the door part, and
pressing the leaf spring into the door column.

A second embodiment of the method is characterized by the steps:
inserting the leaf spring into a tool design for plastic coating,
insert moulding the leaf spring, and
forming the door column by plastic coating.

A third embodiment of the method is characterized by the steps:
forming the door column by plastic coating,
inserting the leaf spring into a channel for receiving the door part, and
welding the leaf spring with the door column.

A fourth embodiment of the method is characterized by the steps:
forming the door column by plastic coating,
inserting the leaf spring into a channel for receiving the door part, and
shrinking the leaf spring in the door column, before the door column has been cooled down.

In all methods described above no additional fixing elements are required.

Novel and inventive features of the present invention are set forth in the appended claims.

The present invention will be described in further detail with reference to the drawings, in which

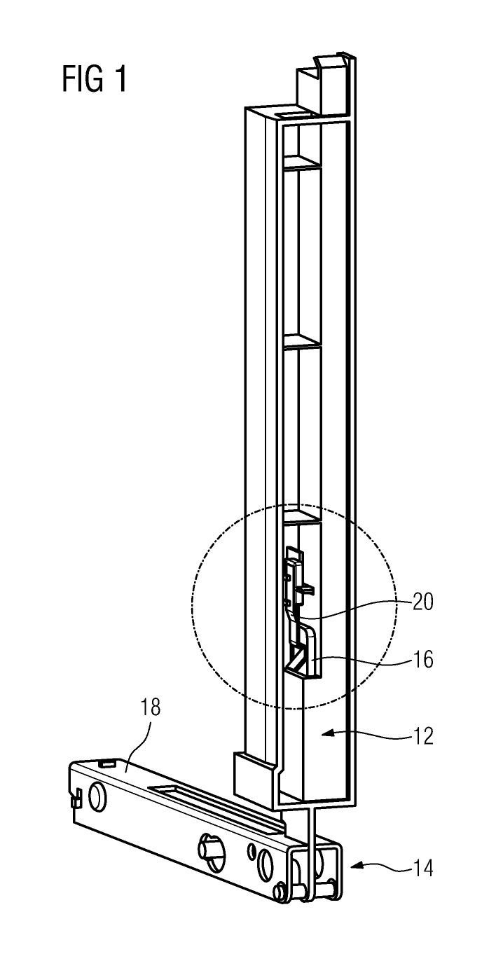

FIG. 1 illustrates a perspective view of a plastic door column with a door hinge for an oven door according to a preferred embodiment of the present invention,

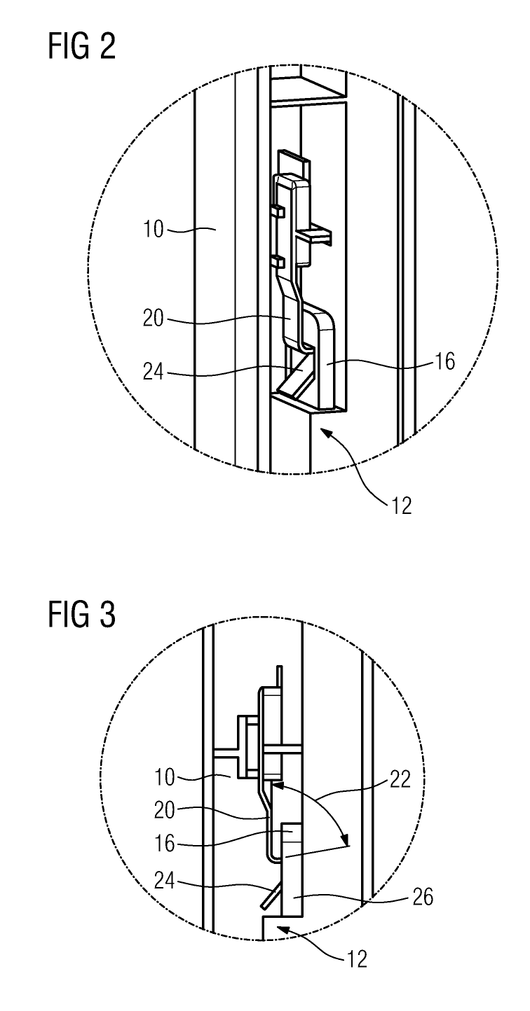

FIG. 2 illustrates a detailed perspective view of the plastic door column with a leaf spring for the oven door according to the preferred embodiment of the present invention, and

FIG. 3 illustrates a detailed sectional view of the plastic door column with the leaf spring for the oven door according to the preferred embodiment of the present invention.

FIG. 1 illustrates a perspective view of a plastic door column 10 with a door hinge 14 for an oven door according to a preferred embodiment of the present invention.

The oven door comprises preferably two plastic door columns 10 and two corresponding door hinges 14 and at least one door panel arranged between the two plastic door columns 10. The door panel and the other plastic door column with the corresponding door hinge are not shown in FIG. 1.

The door hinge 14 includes an elongated door part 16 and an elongated oven part 18. In a closed state of the oven door the door part 16 and the oven part 18 form an angle of about 90°. In an open state of the oven door the door part 16 and the oven part 18 form an angle between about 170° and 180°. The state shown in FIG. 1 corresponds with the closed state of the oven door.

The plastic door column 10 includes a channel 12 for receiving the door part 16 of the door hinge 14 the channel 12 extending approximately parallel to a longitudinal axis of the door column 10 from one end of the column. The plastic door column 10 is detachably mounted at the door part 16 of the door hinge 14. A leaf spring 20 is durably fixed within the channel 12 of the plastic door column 10. The leaf spring 20 is provided for clamping the door part 16 of the door hinge 14.

FIG. 2 illustrates a detailed perspective view of the plastic door column 10 with the leaf spring 20 for the oven door according to the preferred embodiment of the present invention. FIG. 2 clarifies the structure of the leaf spring 20 and the door part 16 of the door hinge 14.

A section of the leaf spring 20 is complementary to a corresponding section of the door part 16. The leaf spring 20 includes a lug 24. The door part 16 includes a recess 26. The lug 24 of the leaf spring 20 and the recess 26 of the door part 16 form a snap-in mechanism. The recess 26 is marginally bigger than the lug 24.

FIG. 3 illustrates a detailed sectional view of the plastic door column 10 with the leaf spring 20 for the oven door according to the preferred embodiment of the present invention. FIG. 3 clarifies the form of the leaf spring 20 and its position with the recess 26 of the door part 16 in the mounted state.

An outer side of the lug 24 forms an acute angle 22 with the principle plane of the leaf spring 20. In this example the acute angle 22 is more than about 70° and less than 90°. The acute angle 22 of the lug 22 forms an undercut. An inner side of the lug 24 forms an obtuse angle with the principle plane of the leaf spring 20. In this example the obtuse angle is between about 120° and 150°.

The lug 24 of the leaf spring 20 and the recess 26 of the door part 16 allow the user an easy removing and fastening of the oven door. The lug 24 of the leaf spring 20 snaps-in, when the oven door is pushed over the door parts 16 of the door hinges 14 and fastened. When the oven door is removed, the user has to spend a bigger force because of the acute angle 22 of the leaf spring 20. Said bigger force prevents an unintended removing of the door.

The leaf spring 20 is directly fixed at the plastic door column 10. No additional fixing elements are required. There are several methods for inserting and fixing the leaf spring 20 at the plastic door column 10.

For example, after forming the door column 10 by plastic coating, the leaf spring 20 is inserted into the channel 12 and the leaf spring 20 is pressed into the door column 10.

According to another example, after inserting the leaf spring 20 into a tool design for plastic coating, the leaf spring 20 is insert-moulded and the door column 10 is formed by plastic coating.

Alternatively, after forming the door column 10 by plastic coating, the leaf spring 20 is inserted into the channel and the leaf spring 20 is welded with the door column 10.

Further, after forming the door column 10 by plastic coating, the leaf spring 20 may be inserted into the channel 12 and the leaf spring 20 shrinks in the door column 10, before said door column 10 has been cooled down.

The complexity of said methods is very low, since no additional fixing elements are required.

Although illustrative embodiments of the present invention have been described herein with reference to the accompanied drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

### List of Reference Numerals

10 plastic door column
12 channel
14 door hinge
16 door part of the door hinge
18 oven part of the door hinge
20 leaf spring
22 acute angle
24 lug
26 recess

1-14. (canceled)

15. An oven door with at least one elongated door column, in particular plastic door column, and at least one corresponding door hinge, wherein:
the door hinge includes an elongated door part and an oven part,
the door column includes an elongated channel for receiving the door part of the door hinge, the channel preferably extending from one end of the door column at least mainly parallel to the longitudinal axis of said door column,
the door part is detachably mountable or detachably mounted within the channel,
a leaf spring for clamping the door part is durably or permanently fixed within the channel,
the leaf spring is fixed directly at the door column or at the door part of the door hinge, and
a section of the leaf spring is complementary with a corresponding section of the door part or door column.

16. The oven door according to claim 15, characterized in, that the leaf spring and the door part or door column form a snap-in mechanism.

17. The oven door according to claim 15, characterized in, that the leaf spring includes at least one lug directed to the door part or door column in a mounted state.

18. The oven door according to claim 17, characterized in, that the door part or door column includes at least one recess for receiving the lug of the leaf spring.

19. The oven door according to claim 17, characterized in, that an outer side of the lug forms an acute angle with a principle plane of the leaf spring.

20. The oven door according to claim 19, characterized in, that an inner side of the lug forms an obtuse angle with the principle plane of the leaf spring.

21. The oven door according to claim 18, characterized in, that the snap-in mechanism is formed by the lug of the leaf spring and the recess.

22. A door column, in particular a plastic door column, for an oven door, comprising:
a door hinge includes an elongated door part and an oven part,
wherein the door column includes an elongated channel for receiving the door part of the door hinge, the channel preferably extending from one end of the door column at least mainly parallel to the longitudinal axis of said door column,
the door part is detachably mountable or detachably mounted within the channel,
a leaf spring for clamping the door part is durably or permanently fixed within the channel,
the leaf spring is fixed directly at the door column or at the door part of the door hinge, and
a section of the leaf spring is complementary with a corresponding section of the door part or door column.

23. A method for assembling a door column, in particular a plastic door column, for receiving a door part of a door hinge and a leaf spring for clamping the door part, wherein:
the door column is formed as a single-piece part, in particular by plastic coating,
the leaf spring is directly fixed at the door column or door part, and
at least one fixing element for fastening the leaf spring is formed as an integral part of the door column or door part.

24. The method according to claim 23, characterized by the steps of:
forming the door column by plastic coating,
inserting the leaf spring into a channel for receiving the door part, and
pressing the leaf spring into the door column.

25. The method according to claim 23, characterized by the steps of:
inserting the leaf spring into a tool design for plastic coating,
insert moulding the leaf spring, and
forming the door column by plastic coating.

26. The method according to claim 23, characterized by the steps of:
forming the door column by plastic coating,
inserting the leaf spring into a channel for receiving the door part, and
welding the leaf spring with the door column.

27. The method according to claim 23, characterized by the steps of:
forming the door column by plastic coating,
inserting the leaf spring into a channel for receiving the door part, and
shrinking the leaf spring in the door column, before the door column has been cooled down.

28. The method according to claim 23, characterized in, that the method is provided for assembling a door column, in particular a plastic door column, wherein:
the door hinge also includes an oven part,
wherein the door column includes an elongated channel for receiving the door part of the door hinge, the channel preferably extending from one end of the door column at least mainly parallel to the longitudinal axis of said door column,
the door part is detachably mountable or detachably mounted within the channel,
the leaf spring for clamping the door part is durably or permanently fixed within the channel,
the leaf spring is fixed directly at the door column or at the door part of the door hinge, and
a section of the leaf spring is complementary with a corresponding section of the door part or door column.
